(19) United States
(12) Patent Application Publication
(10) Pub. No.: US 2025/0168570 A1
(43) Pub. Date: May 22, 2025

(54) Loudspeaker voice coil bobbins

(71) Applicant: GP Acoustics (UK) Limited, Maidstone (GB)

(72) Inventor: Mark Alexander Dodd, Budleigh Salterton (GB)

(21) Appl. No.: 18/953,691

(22) Filed: Nov. 20, 2024

(30) Foreign Application Priority Data
Nov. 21, 2023 (GB) 2317791.8

(51) Int. Cl. H04R 9/06

(52) U.S. Cl. CPC H04R 9/06

(57) ABSTRACT

A voice coil bobbin for a loudspeaker for driving a sound-radiating diaphragm to reciprocate along an axis, the voice coil bobbin 2 extending axially along the axis and circumferentially around the axis, the voice coil bobbin being configured with perforations 6 so as to provide at least two rows 4a, 4b of arcuate spars 10 disposed circumferentially around the voice coil bobbin, each arcuate spar 10 being adapted to flex, cantilever-fashion, in an axial direction in response to the voice coil bobbin being driven axially and allowing the axial length of the voice coil bobbin to vary, the arcuate spars having a circumferential length of at least 25% of the circumferential length of the perforations 6.

### FIELD OF THE INVENTION

The present invention relates to the field of loudspeakers, and in particular to loudspeaker voice coil bobbins and to loudspeakers incorporating such voice coil bobbins.

### BACKGROUND ART

The structure and operation of moving coil loudspeaker drive units is well known. A vibration diaphragm is attached to a voice coil driver, and the voice coil driver is placed in a magnetic field usually provided by one or more permanent magnets. By passing an alternating current through the voice coil a force is induced, causing the voice coil driver to reciprocate and hence the diaphragm to vibrate and so radiate acoustic waves. The voice coil driver usually comprises a voice coil bobbin, or former, around which an electrically conductive wire is coiled; the bobbin and wire coil form a unitary item and they vibrate as one. Voice coil bobbins are usually (but not always) cylindrical. In some applications, where mass is critical and/or space is limited, voice coil bobbins are made of materials such as titanium or Nomex (Nomex is a trade mark of DuPont Safety & Construction, inc., of Delaware, USA). Titanium voice coil bobbins are normally formed from a flat strip of material which is rolled into a cylindrical shape; usually the axial ends of the rolled strip are not joined together, which leaves a thin axial gap extending along the length of the voice coil bobbin, across which circumferential forces cannot be balanced by symmetry. Consequently the ‘hoop’ stiffness which acts on circumferential forces due to axisymmetry is greatly reduced near the gap in the bobbin.

The use of a mechanically compliant member attached to, or forming part of, a loudspeaker voice coil bobbin has long been known as a means of adapting loudspeaker frequency response. In early arrangements, multiple voice coils and external electrical circuits were used, but more recent applications have been simpler. For example, a flexible and damped link between a speaker and a voice coil driver may work in conjunction with an electric network to form a loudspeaker system crossover network. Alternatively, a voice coil driver may have a complete mechanical crossover formed by a link.

One simple arrangement for introducing axial compliance into a voice coil driver has been to provide mechanically compliant members which extend axially between the voice coil and the diaphragm, such as in GB2516936, which act as a mechanical low-pass filter to absorb energy from frequency components of oscillations of the voice coil driver above a normal operating band. Such arrangements complicate the design and manufacture of the voice coil bobbin, which must comprise at least two different materials, of differing stiffnesses, in order to function. Moreover, such designs are not suitable where the bobbin has to be particularly stiff, and is made of titanium or the like.

Another known arrangement for introducing axial compliance into a voice coil driver has been to provide one or more corrugations in the voice coil bobbin, the effect of which is to allow the two parts of the voice coil bobbin either side of the corrugation(s) to flex in similar manner to a bellows. The earliest patents covering such designs are U.S. Pat. Nos. 2,007,747 and 2,007,748; in which multiple voice coils and electrical filters are intended to improve the frequency response of a drive unit. In one embodiment, a driver was proposed with two coils, a low mass coil rigidly coupled to the diaphragm and a larger high mass coil coupled through a compliant member to the low mass coil. An electrical filter circuit directs high frequency current to the low mass coil and low frequencies to the high mass coil. The compliant member and mass of the coils form a mechanical filter allowing the force of the high mass coil to displacing the diaphragm and low mass coil at low frequencies while at high frequencies the low mass coil is energised and displaces the diaphragm without displacing the high mass coil.

There are significant difficulties in manufacturing a voice coil bobbin with a corrugation:
1. Thermoset and fibre reinforced materials cannot be accurately formed.
2. A material with a corrugation formed in a flat sheet will deform when wrapped into a cylinder for a bobbin, and it is impossible to form a corrugation with the necessary accuracy in a cylindrical bobbin.
3. The tendency of some materials to “spring back” makes it hard to manufacture the precise shape required.
4. The size of the corrugation required may be too large to fit in some applications.
5. Altering the shape or size of the corrugations to adjust the compliancy of a corrugation requires expensive tooling changes.

There is a need for an arrangement which introduces axial compliancy into a voice coil which is relatively simple, easily manufactured and easily “tuneable”, in particular (but not exclusively) for loudspeakers in which mass is critical and/or space is limited, such as in compression drivers. Moreover, there is a need for a mechanical axial compliance arrangement which can be tuned relatively easily to account for voice coil bobbins which have been rolled into shape and have a thin axial gap extending along the length of the voice coil bobbin. One application that may benefit from introducing a resonance would be a compression driver where the mass results in a 6 dB/Octave low pass filter typically from 2-3 kHz. In many cases the output level in the upper part of the response is lower than desired and introducing a resonance by making the bobbin axially compliant produces a more desirable response. This can be seen from a ‘lumped element’ model of an example driver using a 0.025 mm thick Titanium bobbin as shown in FIG. 2a. In this case the resistive impedance of the plane wave tube provides some damping.

JP 2006 074410 proposes introducing a compliance imparting portion to the voice coil bobbin between the diaphragm and the voice coil winding in the form of a plurality of slit holes extending evenly around the circumference of the voice coil bobbin. JP 2006 074410 discloses two embodiments, a first in which there are two circumferential rows of slit holes, and a second embodiment in which there is only a single row of slit holes; in both embodiments, the arrangement of the slit holes is such that the total circumferential length of all of the slit holes in any one row is 50% or more of the circumference of the voice coil bobbin. At paragraphs [0020] and [0024] referring to the three SPL curves in FIG. 3, JP 2006 074410 explains that, compared with a conventional voice coil bobbin, in the first embodiment the high frequency resonance peak can be greatly reduced, and the cutoff characteristics of the high frequency range also sharply attenuated; in the second embodiment the high-frequency resonance peak can be reduced and the cut-off characteristics of the high-frequency range are also improved, compared with both a conventional voice coil bobbin and the first embodiment. We believe that the inventor in JP 2006 074410 did not understand the different mechanical features and characteristics of the embodiments he described which contribute to impart compliance.

### SUMMARY OF THE INVENTION

The present invention is predicated on the realisation that a relatively simple mechanical compliance arrangement can be provided by exploiting the relatively easily calculated effects of cantilevers, and that certain arrangements of cantilevers can be used to form a voice coil driver with a significantly improved overall performance compared to conventional systems. Although JP 2006 074410 discloses a first embodiment in which cantilevers are present, and are about 20% of the circumferential length of the slit holes, it also teaches that the second embodiment, in which there are no cantilevers, provides better performance than the first embodiment.

The present invention therefore provides a voice coil bobbin for a loudspeaker compression driver for driving a sound-radiating diaphragm to reciprocate along an axis, the voice coil bobbin extending axially along the axis and circumferentially around the axis, the voice coil bobbin having at least two axially-spaced rows of perforations extending circumferentially or at least partly circumferentially around the axis, adjacent rows being rotated relative to each other such that adjacent perforations overlap circumferentially to form arcuate spars therebetween disposed circumferentially around the voice coil bobbin, each arcuate spar being adapted to flex, cantilever-fashion, in an axial direction in response to the voice coil bobbin being driven axially and allowing the axial length of the voice coil bobbin to vary, in which the overlap between adjacent perforations in adjacent rows is such that the length of the arcuate spars is at least 25% of the circumferential length of the adjacent perforations.

In such an arrangement, the spars form a structural link transmitting the force between the part of the bobbin on which the voice coil is wound and the part of the bobbin attached to the diaphragm. The spars flex in a spring-like manner and when deflected a restoring force is produced making the arrangement behave as a spring linking the coil and diaphragm in a similar manner to a corrugation on a bobbin. A circumferential alignment of the spars provides increased flexibility when compared to an axial spar. The bobbin and the spars are preferably of constant radial thickness whatever the axial position along the length of the bobbin; this makes axial deformation of the bobbin both predictable and circumferentially constant.

The spars are manufactured by making a plurality of perforations in the bobbin, by removing material from the bobbin so one part of the bobbin is linked by means of the circumferential array of flexing spars to the other part of the bobbin, which is joined to the diaphragm. By varying the length, axial depth, location, orientation or number of spars the axial compliance may be varied over a large range of values allowing the desired axial compliance to be achieved. The length of the spars may be 30%, 35% or 40% of the circumferential length of the adjacent perforations; the longer the spars, the more they can bend under a given axial load and the more compliance is introduced into the voice coil bobbin. The overlap must be less than 50%, or successive slots will merge with one another and will create a clean break in the bobbin; a maximum overlap of 40% is preferred so that the circumferential dimension of the axially-extending part between adjacent perforations is sufficiently stiff. Depending on the type of material to be removed, press tool forming, laser cutting, precision photoetching, high accuracy microjet water cutting, plasma cutting, or micro-milling are possible manufacturing methods. Further, these spars can be varied (in location, size, shape or orientation, for example) so as readily to compensate for varying circumferential effects resulting from the axial gap where the bobbin is shaped by rolling, and/or to vary the axial stiffness of the bobbin at different points around its circumference. In general, the longer a spar is, the greater are the manufacturing tolerances which achieve an acceptable variation in response; this allows economic manufacture of the bobbin.

The perforations may extend circumferentially or at least partly circumferentially or at least having a part with a circumferentially directed component around the axis, the arcuate spars being formed along at least a part of each perforation. In this case, a single row of perforations may provide spars to give the bobbin the required axial compliance. There may be one, two or any number of circumferential rows of perforations extending around the axis, the perforations being oriented and/or shaped so as form arcuate spars adapted to flex, cantilever-fashion.

There are two circumferential rows of perforations extending around the axis and spaced axially so that the voice coil bobbin between perforations in adjacent rows forms the arcuate spars. Such an arrangement, with two rows of perforations, is both simple to manufacture and provides spars which give axial mechanical compliance which is relatively easily calculated using Finite Element Method (FEM) analysis; it is also most easily tuned to accommodate non-axisymmetry (presence of an axial gap) or to provide axial compliance which is itself non-axisymmetric.

The perforations may provide air venting, alternatively at least some of the perforations may be filled with either a damping material which is sound absorbent, and more flexible than the material of which the voice coil bobbin is made, to provide damping of air flow through the perforations, and/or at least some of the perforations may be covered with a flexible material which is impervious to air (and more flexible than the material of which the voice coil bobbin is made) to prevent air flow through the perforations, according to the particular application.

The perforations may be of substantially the same shape, which ensures that all the spars are similar, making for case of manufacture and allowing relatively easy calculation of the axial compliance effects of the spars. Alternatively, the perforations may be of different shapes, which may be helpful in tuning axial compliance circumferentially.

The perforations may be of substantially the same size, which ensures that all the spars are similar, making for case of manufacture and allowing relatively easy calculation of the axial compliance effects of the spars. Alternatively, the perforations may be of different sizes, and/or of different circumferential lengths, which may be helpful in tuning axial compliance circumferentially.

The perforations may be separated circumferentially by substantially the same distance circumferentially and/or axially, which ensures that all the spars are similar, making for case of manufacture and allowing relatively easy calculation of the axial compliance effects of the spars. Alternatively, the perforations may be separated by different distances, which may be helpful in tuning axial compliance circumferentially.

The perforations may be oriented similarly, which ensures that all the spars are similar, making for case of manufacture and allowing relatively easy calculation of the axial compliance effects of the spars. Alternatively, the perforations may be oriented differently, which may be helpful in tuning axial compliance circumferentially.

A voice coil bobbin may comprise two axially concentric parts, each part forming a voice coil bobbin as described above and each comprising a plurality of perforations formed therein and extending circumferentially around the axis. Such arrangements are suitable where low mass is not so critical. Damping may be provided by incorporating a layer of visco-elastic film sandwiched between and affixed to the two concentric layers of bobbin material. This results in a mechanical resistance between the two parts linked by the flexing spars damping the resonance.

The concentric parts may be displaced circumferentially and/or axially so that the perforations in the two parts are not aligned. Rotating the outer part relative to the inner part provides the most shear due to axial motion. Rotating by half the angle between the flexing spars provides the highest damping, less rotation provides less damping allowing some control over the mechanical resistance. Again, a viscoelastic material may be sandwiched between and affixed to the two concentric parts.

The present invention extends to voice coil drivers, compression drivers and loudspeakers incorporating a voice coil bobbin as described herein.

### BRIEF DESCRIPTION OF THE DRAWINGS

The invention will now be described by way of example and with reference to the accompanying figures, in which;

FIG. 1a is a schematic illustration of one embodiment of a voice coil bobbin in accordance with the present invention and FIG. 1b is an enlarged view of part of the voice coil bobbin of FIG. 1a;

FIGS. 2a, 2b and 2c are plane wave tube simulation SPL response curves of conventional voice coil bobbins and voice coil bobbins in accordance with the present invention;

FIG. 3 is a schematic view of the voice coil bobbin of FIG. 1 in a compression driver diaphragm assembly such as that in our EP2952014/U.S. Pat. No. 9,467,782;

FIGS. 4a, and 4b are enlarged schematic views of part of alternative embodiments of voice coil bobbins;

FIG. 5 is an enlarged view of part of the voice coil bobbin of FIG. 1 showing an axial gap extending along the bobbin;

FIGS. 6a, 6b and 6c are enlarged schematic views of part of alternative embodiments of voice coil bobbins in which there are two concentric bobbin parts.

### DETAILED DESCRIPTION OF THE EMBODIMENTS

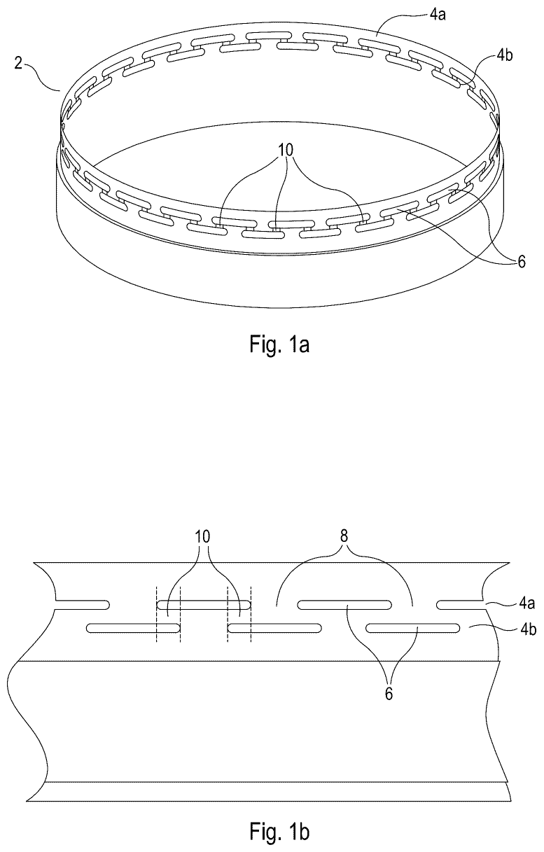

FIG. 1a shows a voice coil bobbin 2 having two, axially spaced rows 4a, 4b of perforations 6, each perforation 6 having the shape of a slot formed by two half-circles joined by straight edges, where the straight edges extend circumferentially. In this example, the bobbin is 0.025 mm thick titanium, rolled into a cylinder approximately 34 mm in diameter, and there are 28 perforations/slots in each row; each slot is approximately 2.2 mm long, 0.2 mm wide with a 0.1 mm radius at each end, and is spaced approximately 1.1 mm from the next slot in that row. The formed bobbin has a substantially constant thickness along its axial length. As shown more clearly in FIG. 1b, between adjacent perforations 6 in each row is an axially-extending part 8, and the rows 4a, 4b are rotated relative to each other so that each axially-extending part 8 is aligned with the middle of the closest slot; this forms a circumferentially-extending spar 10 either side of each axially-extending part 8, between the ends of the slots in the two rows where they overlap (the spars 10 are also shown darkly shaded in FIG. 1, although for clarity these do not show the spars extending to the radiused ends of the perforations, which is the actual case, as shown in FIG. 1b). Each spar is arcuate because it is formed on the surface of a cylinder. In the embodiment shown there are 56 circumferential spars in total (two spars per slot); each spar is 0.7 mm in circumferential length and 0.3 mm in axial depth (i.e. the axial distance (vertical in the drawing) between the two rows 4a, 4b). The overlap (i.e. the length of each circumferentially-extending arcuate spar) is in this case approximately 27% of the circumferential length of each perforation.

By varying the sizes of the slots, their circumferential separation distances and/or the distance between the rows it is possible to vary the axial compliance of this arrangement to suit a particular requirement/application, and this axial compliance can be relatively easily calculated.

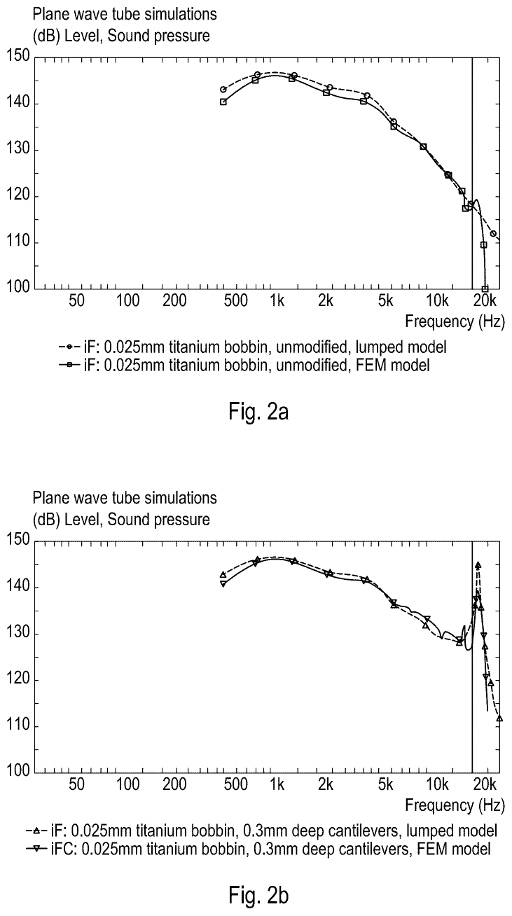

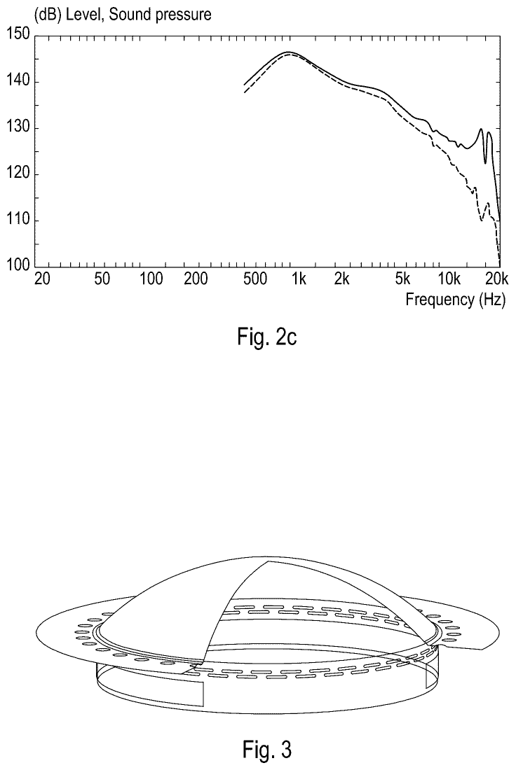

FIG. 2a shows the lumped element model (“lumped model”) and finite element method (“FEM Model”) simulated SPL responses for a 0.025 mm conventional cylindrical titanium bobbin driving a compression driver. The figure shows a good match between the SPL response of the lumped model and FEM model apart from the very highest frequencies where acoustic and structural modes limit the bandwidth. The vertical line on the graph is at 20 kHz, the upper limit of the working band. The FEM model has a frequency limit of 25 kHz due to computational limitations. In this case the resistive impedance of the plane wave tube provides some damping.

Unlike a direct radiator where a linear response is a possible outcome, a compression driver has a 6 dB/octave low pass filter characteristic above 2 kHz extending up to the highest working frequency. This 2 kHz first order low pass characteristic limits the high frequency output of compression drivers. Introducing a resonance towards the upper part of the desired working bandwidth can provide a significant boost in output, resulting in a boosted region of response below the resonance. For example, adding a spring with 2 M/n stiffness to the lumped model between coil and diaphragm results in a resonance at 21.8 kHz.

FIG. 2b shows the lumped and FEM model simulated response curve of the same compression driver driven by a voice coil bobbin incorporating fifty-six 0.7 mm long by 0.3 mm axial depth spars, while FIG. 2c shows the FEM model simulated response curves for a conventional, unmodified bobbin without spars (lower curve) and with spars (upper curve). It can be seen that, with spars 0.7 mm in circumferential length and 0.3 mm in axial depth the output at 20 kHz is boosted relative to the unmodified bobbin from 117 dB to 129.5 dB.

FIG. 3 shows the voice coil bobbin 2 of FIG. 1 in a compression driver diaphragm assembly with a diaphragm such as that disclosed in our EP2952014/U.S. Pat. No. 9,467,782. Unlike diaphragm resonances where the radiation coupling is weak due to the irregular motion of the diaphragm the increased axial motion at the driving point of the diaphragm couples as strongly as the motion due to the voice coil. This allows very high levels of gain to be achieved over a relatively wide bandwidth.

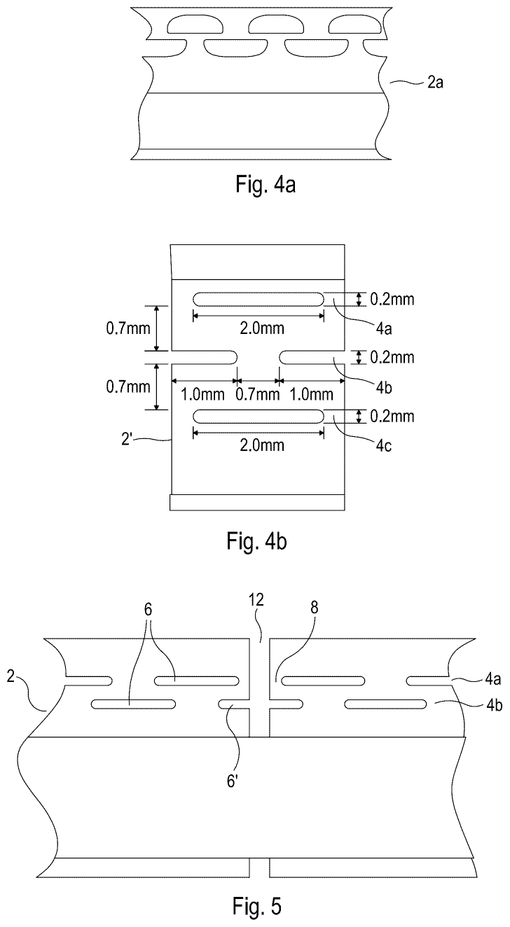

FIG. 4a shows the enlarged part of a bobbin 2a similar to that of FIG. 1a, but with differently-shaped perforations; provided the size of the perforations adjoining the spars is maintained constant, the shape of the perforations has little impact on the stiffness of the spars. In this example a ‘D’ shaped perforation behaves in almost exactly same manner as the racetrack perforation of FIG. 1, and the overlap between adjacent perforations in adjacent rows is such that the length of the arcuate spars is approximately 27% of the circumferential length of the adjacent perforations. The perforations could be any shape (e.g. semi-circular, semi-ovoid semi-elliptical) provided the shape of the perforation edges forming the circumferential spars remains substantially constant/straight.

FIG. 4b shows a portion of another voice coil bobbin 2′ similar to that in FIG. 1b but with three rows 4a, 4b, 4c of similarly sized and shaped perforations, and with a greater degree of circumferential overlap between perforations in adjacent rows (and longer circumferentially-extending arcuate spars) of approximately 33% of the circumferential length of the perforations, which provides the voice coil bobbin with a greater amount of axial compliance than the FIG. 1 embodiment.

FIG. 5 shows an enlarged view of part of the voice coil bobbin of FIG. 1 (but here the overlap between perforations is such that the length of the arcuate spars is approximately 25% of the circumferential length of the adjacent perforations), this time showing the axial gap 12 extending along the bobbin. By ensuring the gap 12 is between the slots, preferably equidistant and bisecting an axially-extending part 8 in one of the rows 4a and a slot 6′ in the other of the rows 4b, a bobbin with flexing spars may be designed so there is little variation in the local axial stiffness around the circumference of the bobbin. If necessary, the length and thickness of spars adjoining the gap in the bobbin may be adjusted to correct any reduction in stiffness due to the change in geometry.

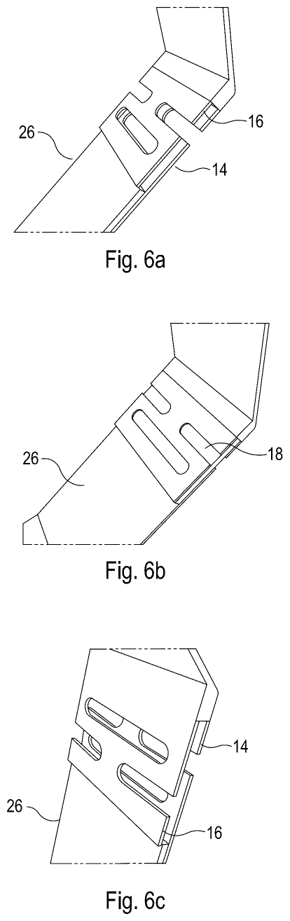

The embodiments of FIGS. 1, 3, 4 and 5 are all compression drivers, but the invention is also applicable to other forms of loudspeaker. FIGS. 6a, 6b and 6c each show a part of a voice coil bobbin 26 for a cone radiator which comprises two axially concentric parts, the inner part 14 and outer part 16 each comprising a bobbin 2 as described above in relation to FIG. 1. The sound-radiating horn in such a loudspeaker has a similar function to the diaphragm of a compression driver, and such loudspeakers have the same requirement for axial damping, which may be addressed in accordance with the present invention. In FIG. 6a the inner and outer parts are shown alone for clarity, in FIG. 6b there is a visco-clastic film 18 of greater flexibility of the material of the voice coil bobbin sandwiched between the two parts which acts as a damping material (preferably the film 18 is also adapted to adhere the two parts together); this results in a mechanical resistance between the two parts linked by the flexing spars which damps resonance. FIG. 6c shows the two parts 14, 16 of the bobbin of FIGS. 6a and 6b (with the damping material omitted for clarity) but with the outer part rotated circumferentially relative to the inner part. Offsetting the spars in the two parts in this way is effective to increase the shear forces and thus damping due to axial motion of the spars in the two parts. Rotating by half the angle between the flexing spars as shown in the drawing provides the highest damping, less (or more) rotation than this, without returning to the aligned position in FIG. 6a provides less damping, thus allowing some control over the mechanical resistance.

It will of course be understood that many variations may be made to the above-described embodiment without departing from the scope of the present invention. For example, the present invention is principally described with reference to cylindrical voice coils (in the form of a substantially planar ring with a central hole); however, the invention applies equally to non-circular arrangements, such as oval, elliptical or race track shaped (figure of eight, or triangular/square/polygonal with rounded corners) voice coils, or any shape being symmetrical in one or two orthogonal directions lying in the general plane perpendicular to the voice coil axis and having a central hole. The inner and outer parts of the arrangement in FIG. 6 may be offset axially, as well as or instead of the circumferential offset shown in FIG. 6c. In any of the embodiments illustrated, damping material may be provided in some or all of the perforations, and/or flexible material which is impervious to air may be provided covering the inner or outer surface of any of the perforations. The embodiments described are all titanium, but they could be formed of a thermoset or polyimide composite material.

Where different variations or alternative arrangements are described above, it should be understood that embodiments of the invention may incorporate such variations and/or alternatives in any combination for different applications, so that the features of different embodiments can be combined to form further embodiments. For example, in a one-part bobbin each circumferential row of perforations may contain perforations all of the same size, shape and orientation, or any of these features may be varied in a row; additionally or alternatively the perforations in a row may be regularly spaced apart, or they may be irregularly spaced and in either case the perforations may be of the same length or of different lengths. Any or all of these combinations may equally be applied to a voice coil bobbin having three or more rows of perforations. A two-part bobbin may comprise any variation of the aforesaid one-part bobbins; for example, the inner part may be a bobbin as shown in FIG. 1 and the outer part may be a bobbin as shown in FIG. 4.

Those skilled in the art will understand that, where attributes, advantages and/o applications are described hereinabove in relation to only one embodiment, these attributes, advantages and applications apply equally to other embodiments which share the same or similar features as the one embodiment described, even though this has not been explicitly stated herein for reasons of conciseness.

1. A voice coil bobbin for a loudspeaker for driving a sound-radiating diaphragm to reciprocate along an axis, the voice coil bobbin extending axially along the axis and circumferentially around the axis, the voice coil bobbin having at least two axially-spaced rows of perforations extending circumferentially or at least partly circumferentially around the axis, adjacent rows being rotated relative to each other such that adjacent perforations overlap circumferentially to form arcuate spars therebetween disposed circumferentially around the voice coil bobbin, each arcuate spar being adapted to flex, cantilever-fashion, in an axial direction in response to the voice coil bobbin being driven axially and allowing the axial length of the voice coil bobbin to vary, in which the overlap between adjacent perforations in adjacent rows is such that the length of the arcuate spars is at least 25% of the circumferential length of the adjacent perforations.

2. The voice coil bobbin according to claim 1, in which the overlap between adjacent perforations in adjacent rows is such that the length of the arcuate spars is at least 30% of the circumferential length of the adjacent perforations.

3. The voice coil bobbin according to claim 1, in which the overlap between adjacent perforations in adjacent rows is such that the length of the arcuate spars is at least 35% of the circumferential length of the adjacent perforations.

4. The voice coil bobbin according to claim 1, in which the overlap between adjacent perforations in adjacent rows is such that the length of the arcuate spars is at least 40% of the circumferential length of the adjacent perforations.

5. The voice coil bobbin according to claim 1, in which at least some of the perforations are filled with a flexible, sound absorbent, damping material.

6. The voice coil bobbin according to claim 1, in which at least some of the perforations are covered with a flexible material impervious to air.

7. The voice coil bobbin according to claim 1, in which the perforations are of substantially the same shape.

8. The voice coil bobbin according to claim 1, in which the perforations are of substantially the same size.

9. The voice coil bobbin according to claim 2, in which the perforations are separated by substantially the same distance circumferentially and/or axially.

10. A voice coil bobbin comprising two axially concentric parts, each part forming a voice coil bobbin according to claim 1 and each comprising at least two rows of perforations formed therein and extending circumferentially around the axis.

11. The voice coil bobbin according to claim 7 in which the two axially concentric parts are displaced circumferentially and/or axially so that the perforations in the two parts are not aligned.

12. The voice coil bobbin according to claim 7 comprising a viscoelastic material sandwiched between and affixed to the two concentric parts.

13. A voice coil driver comprising a voice coil bobbin according to claim 1.

14. A loudspeaker comprising a voice coil bobbin according to claim 1.
